(19) United States
(12) Patent Application Publication
(10) Pub. No.: US 2005/0211337 A1
(43) Pub. Date: Sep. 29, 2005

(54) Apparatus for shifting log sideways relative to grapple head assembly

(76) Inventor: Rodney Warwick Sharp, Hamilton (NZ)

Correspondence Address: YOUNG & THOMPSON, 745 SOUTH 23RD STREET, 2ND FLOOR, ARLINGTON, VA, 22202, US

(21) Appl. No.: 11/092,558

(22) Filed: Mar. 29, 2005

(30) Foreign Application Priority Data
Mar. 29, 2004 (NZ) 532009

(51) Int. Cl. A01G 23/08; B27M 3/00; A01G 23/095

(52) U.S. Cl. 144/335; 144/4.1; 144/34.1

(57) ABSTRACT

The present invention relates to modification to a grapple (1) to allow lengthwise movement of a load such as a log (12). When a cut-off saw (30) is attached, a load contacting portion (6) can be used to fine adjust the longitudinal position of the log (12) relative to the grapple (1), and hence cut-off saw (30). This provides for finer control and more accurate positioning of the cut-off saw than is generally achievable by movement of the grapple (1) relative to the log (12) by an excavator arm, thus enabling logs to be more precisely trimmed by a grapple with cut-off saw arrangement.

### FIELD OF INVENTION

The present invention is directed to grapple head assemblies, particularly for use in the logging and forestry industry. Preferred embodiments of the invention are specifically directed to log carrying grapples with log cut-off saws mounted thereon.

### BACKGROUND DESCRIPTION

While the present invention may be used in a variety of manners, it is with the specific problems of the logging and forestry industry in mind that the present invention has been developed. As a consequence the description herein shall relate primarily to grapples used for lifting logs, typically in forestry, though it should also be recognized that other uses for the invention may exist.

Within the logging industry are grapple head designs which incorporate log trimming saws capable of trimming the log into shorter lengths. This can be quite convenient as, once the log has been lifted and transferred to the desired position, the trimming, or cut-off (as it is sometimes known), saw can be activated and the log cut into smaller segments. Such arrangements allow logs to be trimmed to the preferred sizes for transport.

The previous alternative to trimming saws was to have a separate ground based member of the team who manually trimmed the log into the desired shorter lengths. The disadvantage of this arrangement was the need to employ a skilled person for the task, in addition to the operator of the grapple. This was a significant disadvantage for smaller logging and forestry operations, and also subjected the ground positioned team member to significant risks.

With a grapple mounted trimming saw, the grapple can be moved to the appropriate position so that the trimming saw can cut the log at the desired point along its length. The difficulty imposed in practice, however, is accurately positioning the grapple so that a cut can be made at the desired mark or point. To a large degree this depends upon the skill of the grapple operator, though the environment in which the equipment is working can also affect accuracy.

As a result, most cuts that are made by this system are approximate in position. To precisely cut logs at an exact position would require a time consuming (and difficult) precision alignment of the grapple. The additional time involved with such precision alignment can negate any advantage of mounting a trimming saw on the grapple head assembly. However, inaccurate trimming can have a significant effect on the value which can be extracted from a log.

For instance, timber is a relatively valuable commodity. Modern systems and milling techniques have developed to maximize the extraction of useable lumber from a length of log. Often the evaluation system may begin after the log has been felled, and markings applied to the log as to the exact point along its length where a log should be trimmed. With a ground based team member cutting logs, precise cuts at the desired marked points are achievable. As mentioned above, accuracy is typically only approximate when a grapple head assembly with mounted trim saw is used, and thus such modified grapple heads are not a fully effective substitute for an additional ground based team member.

It would therefore be of use to the industry if a solution could be found which enabled a grapple head assembly with mounted trim saw to more accurately cut the log at the desired or marked points. It would also be useful if this could be accomplished quickly and without expending significant additional operator time attempting to accurately align the grapple head assembly with the mark.

It is therefore an object of the present invention to provide a grapple head assembly, and modifications thereto, which would allow the relative position of a grapple head assembly to a log to be altered without fully removing the grapple head assembly from the log.

It is also an object of the present invention to address the problems outlined above.

At the very least it is an object of the present invention to provide the public with a useful alternative.

Aspects of the present invention will be described by way of example only and with reference to the ensuing description.

### GENERAL DESCRIPTION OF THE INVENTION

According to one aspect of the present invention there is provided grapple head assembly comprising jaws and a head portion, the grapple head assembly also including load position adjustment means in turn comprising at least:
a load contact portion able to be brought to bear against a load, and
means for varying the position of the load contact portion in at least one direction substantially perpendicular to the vertical centerline of the grapple head assembly.

According to another aspect of the present invention there is provided a grapple head assembly, substantially as described above, in which the direction in which the position of the load contact portion may be varied is substantially parallel to the longitudinal axis of a log within the jaws of the grapple.

According to another aspect of the present invention there is provided a grapple head assembly, substantially as described above, in which the load contact portion is positioned, when the grapple head assembly is viewed from the front, substantially underneath the head portion.

According to another aspect of the present invention there is provided a grapple head assembly, substantially as described above, in which the load contact portion is positioned such that a load, when the jaws are brought towards a more closed position, is brought to bear against the load contact portion.

According to another aspect of the present invention there is provided a grapple head assembly, substantially as described above, in which the load contact portion is positioned above a load within the jaws of the grapple.

According to another aspect of the present invention there is provided a grapple head assembly, substantially as described above, in which the load contact portion includes a number of features which can bear against a load which is in proximity.

According to another aspect of the present invention there is provided a grapple head assembly, substantially as described above, in which the features are teeth or teeth-like protuberances.

According to another aspect of the present invention there is provided a grapple head assembly, substantially as described above, in which a tooth has more than one tip, each said tip directed in a different direction.

According to another aspect of the present invention there is provided a grapple head assembly, substantially as described above, in which the load contact portion includes an array of teeth, positioned substantially within a plane but whose tips are arranged in a partial circular or curved pattern when viewed from the side.

According to another aspect of the present invention there is provided a grapple head assembly, substantially as described above, in which the load contact portion includes a plurality of arrays of teeth.

According to another aspect of the present invention there is provided a grapple head assembly, substantially as described above, in which said teeth are formed of a metal.

According to another aspect of the present invention there is provided a grapple head assembly, substantially as described above, in which at least the contacting surfaces of at least some of said teeth are of a resilient material.

According to another aspect of the present invention there is provided a grapple head assembly, substantially as described above, in which at least the contacting surfaces of at least some of said teeth are of a plastics material.

According to another aspect of the present invention there is provided a grapple head assembly, substantially as described above, in which the load contact portion includes a support assembly to which said features are either directly or indirectly attached.

According to another aspect of the present invention there is provided a grapple head assembly, substantially as described above, in which said features are attached to feature supports which are connected to the support assembly.

According to another aspect of the present invention there is provided a grapple head assembly, substantially as described above, in which the support assembly is substantially a plate.

According to another aspect of the present invention there is provided a grapple head assembly, substantially as described above, in which the support assembly is designed to change in shape to accommodate changes in the outer circumference of a log against which the load contact portion is brought to bear.

According to another aspect of the present invention there is provided a grapple head assembly, substantially as described above, in which the support assembly is hinged at at least one point so that it can adopt a jaw like action.

According to another aspect of the present invention there is provided a grapple head assembly, substantially as described above, in which the hinged support assembly is biased, against hinged movement, towards a preferred configuration.

According to another aspect of the present invention there is provided a grapple head assembly, substantially as described above, in which the support assembly can flex so as to change in shape.

According to another aspect of the present invention there is provided a grapple head assembly, substantially as described above, in which the load contact portion is slidable in a left and right direction when the grapple head assembly is viewed from the front.

According to another aspect of the present invention there is provided a grapple head assembly, substantially as described above, in which the support assembly of the load contact portion is supported by guides permitting its sliding movement.

According to another aspect of the present invention there is provided a grapple head assembly, substantially as described above, in which there is included contact portion positioning means for determining the position of the load contact portion relative to the head portion of the grapple head assembly.

According to another aspect of the present invention there is provided a grapple head assembly, substantially as described above, which the contact portion positioning means comprises driving means effecting movement of the load contact portion.

According to another aspect of the present invention there is provided a grapple head assembly, substantially as described above, in which the driving means comprises at least one hydraulic or pneumatic cylinder.

According to another aspect of the present invention there is provided a grapple head assembly, substantially as described above, in which said cylinder is coupled, either directly or indirectly, at one end to the head portion and at the other to the support plate of the load contact portion.

According to another aspect of the present invention there is provided a grapple head assembly, substantially as described above, in which the driving means comprises a motor.

According to another aspect of the present invention there is provided a grapple head assembly, substantially as described above, in which the output of the motor is transmitted to the load contact portion by means of a worm and nut, rack and pinion, or equivalent type of mechanism.

According to another aspect of the present invention there is provided a grapple head assembly, substantially as described above, in which the grapple head assembly is a bunch type grapple.

According to another aspect of the present invention there is provided a grapple head assembly, substantially as described above, in which the grapple head assembly includes an attached cut-off saw.

According to another aspect of the present invention there is provided a grapple head assembly, substantially as described above, in which the total travel of the load contact portion is within the inclusive range of 100 mm-1000 mm.

According to another aspect of the present invention there is provided a grapple head assembly, substantially as described above, in which the total travel of the load contact portion is within the inclusive range of 200 mm-600 mm.

According to a further aspect of the present invention there is provided a grapple head assembly for use with logs, said assembly including a head portion supporting jaws;
the assembly also including a moveable load contact portion moveable in a direction substantially parallel to the longitudinal axis of a log as it is preferentially held within the jaws;
the load contact portion comprising a support element bearing at least one feature which reduces slipping between the load contact portion and a log when the load contact portion is moved;
there being included a cylinder acting against both the head portion and load contact portion for effecting movement of the load contact portion.

According to another aspect of the present invention there is provided a grapple head assembly, substantially as described above, in which the support element is substantially a plate to which are attached, or integrated, a plurality of tooth-like features.

According to another aspect of the present invention there is provided a grapple head assembly, substantially as described above, in which the teeth are arranged in a curved pattern approximating the outer surface of a log which they will bear against.

According to another aspect of the present invention there is provided a grapple head assembly, substantially as described above, in which said assembly includes a cut-off saw.

According to a further aspect of the present invention there is provided load shifting apparatus for modifying a grapple head assembly to be able to move a load in a substantially linear manner, said apparatus comprising a load contact portion, in turn comprising a support portion and guides allowing for linear movement thereof;
there also being included drive means, or provision for the attachment of same, for effecting movement of the support portion relative to the head portion of the grapple head assembly.

According to another aspect of the present invention there is provided load shifting apparatus, substantially as described above, in which the guides for the support portion are attachable to the head portion of the grapple such that the support portion will be supported in a position such that a load encompassed by the jaws of the grapple head assembly can substantially be brought to bear against same.

According to another aspect of the present invention there is provided load shifting apparatus, substantially as described above, in which the drive means comprises a hydraulic cylinder attachable to act on both the head portion of the grapple head assembly, and the support portion.

According to another aspect of the present invention there is provided load shifting apparatus, substantially as described above, in which the support portion bears a number of features able to reduce slipping relative to a load as the support portion is driven to move within the limits of its guides.

According to another aspect of the present invention there is provided load shifting apparatus, substantially as described above, in which the features of the support portion are adapted for use with a log.

According to another aspect of the present invention there is provided load shifting apparatus, substantially as described above, in which the preferred movement of the support portion is in a left and right direction when the modified grapple assembly is viewed from the front.

According to another aspect of the present invention there is provided load shifting apparatus, substantially as described above, in which the total travel of the support portion is within the inclusive range of 100 mm-1000 mm.

According to a further aspect of the present invention there is provided a grapple head assembly modified through the use of load shifting apparatus, substantially as described above.

According to a further aspect of the present invention there is provided a method for altering the relative position of a load comprising a log with respect to a cut-off saw mounted on a grapple head assembly, in which the grapple head assembly is a grapple head assembly substantially as described above, and using the load contact portion of same to adjust the position of the log with respect to the saw.

According to another aspect of the present invention there is provided a method, substantially as described above, in which movement of the log is accomplished by bringing the load contact portion to bear against the top surface of the load, relaxing the jaws, and effecting movement of the load contact portion until the load is in the correct position with respect to the cut-off saw.

According to another aspect of the present invention there is provided a method, substantially as described above, which includes positioning the grapple head assembly such that the cut-off saw is in close proximity to the position of the intended cut, relaxing the jaws while bearing down on the log such that the load contact portion of the load shifting apparatus contacts the log's surface with some force, and moving the load contact portion to effect movement of the log until the cut-off saw is satisfactorily positioned with respect to the position of the intended cut.

In its complete form the present invention comprises a grapple head assembly complete with means for shifting load in at least one longitudinal direction. However, also included within the scope of the present invention are modular assemblies, and kitsets of components suitable for the modification of an existing grapple head assembly. Preferably the present invention is for use with grapples which include a trimming or cut-off saw, or at least provision for the connection of same.

The type of grapple head assembly may vary though in a preferred embodiment a bunching-type of grapple head assembly is used. These types of assemblies are quite commonly used for lifting and moving logs and are the focus of the description herein. However it should be appreciated that the present invention may be applied to other types of grapple head assembly. It is envisaged that a skilled addressee could apply the principles of the invention to other grapple head types on the basis of the description herein.

The present invention may be simply described as comprising an ability to shift a load in at least one direction. Typically, when the load is a log, this direction is substantially parallel to the longitudinal axis of the log. When the log is in a substantially horizontal position then relative movement between the grapple head assembly and the log will also be substantially a movement in a horizontal direction.

Typically movement will not usually occur, at least in preferred embodiments, when the log is either tightly gripped by the jaws, or fully suspended thereby. Preferably sideways adjustment occurs when the grapple's head portion is brought to rest or bear on the load. This gives the, preferably above-the-load positioned, load shifting apparatus an opportunity to purchase the load and slide it. Preferentially the load will be resting on relaxed partially closed jaws, though different operator techniques may vary.

A purpose of providing this side shifting function is to allow the relative position of a load, typically comprising a log to be moved lengthwise with respect to the grapple. This is useful as log trimming saw assemblies are typically mounted directly to the grapple head assembly, and thus movement of the log relative to the head assembly also allows repositioning of the cutting position (on the log) by the attached saw assembly. By providing control over movement of the load relative to the grapple head assembly, a trimming saw which is in the approximate region of the intended position for cutting may then be more accurately aligned with the intended cut position by means of use of the present invention. This is a much simpler process, and also quicker, than attempting to maneuver the grapple head assembly by the equipment to which it is mounted—e.g. an excavator arm or boom. Such maneuvering tends to result in wholesale changes in position and lacks the finesse required for accurate trimming, and reduced wastage. The present invention thus allows for more precise and finer relative movements between the grapple head assembly and a load such as a log.

The present invention may be implemented in a number of ways though preferably includes at least one load contact portion able to bear against a load, typically a log. Preferably this load contact portion should be such that some friction or grip between the load and the contact portion occurs when contact is made—i.e. the load contact portion can make purchase with the load for dragging or pushing it in the preferred direction. The amount of friction may be increased by increasing the weight of the grapple head assembly bearing against the load via the load contact portion—an excavator arm can easily control this. As the load contact portion is ideally positioned to contact the top of the load, relaxing the grapple head assembly such that all or a proportion of its weight rests upon the log via the load contact portion, may be sufficient to induce the desired degree of friction or grip.

The reason for this grip or friction is so that the load contact portion is able to move in a longitudinal direction (preferably corresponding to the longitudinal axis of the log) relative to the remainder of the grapple head assembly. This in turn causes relative movement of the load (log) relative to the grapple head assembly, whether it be by movement of the grapple head assembly with respect to a stationary log, or by movement of the log with respect to the stationary grapple head assembly, or a combination of both. If the load contact portion is allowed to become free to slide relative to the log then the desired movements would not be effectively achieved.

In a preferred embodiment the load contact portion comprises a mounting plate, which is effectively a support, upon which are perpendicularly mounted or integrated a number of teeth or gripping plates having toothed lower edges. The lower edge, bearing the teeth, of these gripping plates is preferably curved in a manner where the radius of curvature is approximately equal to the largest log able to be accommodated by the grapple head assembly. However, other radii of curvature can be employed.

Modifications may be made to the arrangement such that the load contacting portion can more effectively grip logs or loads of differing sizes or shapes. For instance, hinged connections may be provided so that a jaw-like action can result so that the gripping elements (e.g. teeth) can more effectively make contact with a load. These hinges may be in the gripping plates, their connections to the mounting plate, or in various other arrangements. Means for moving the hinged portions may be provided to improve grip and purchase of a load.

As an alternative, which may be in conjunction with hinged arrangements, various components may be flexible to enable the gripping elements to more effectively grip a load. Biasing means may be provided to the flexible or hinged arrangements to bias them to a preferred position. This may enhance gripping, or acceptance, of a load.

The gripping surface of the load contact portion may take various configurations. For instance the gripping portion of the load contact portion may merely comprise teeth attached to a plate. It might also comprise substantially a plate with a molded lower surface configured to improve grip. As can be appreciated spikes, teeth, frictional surfaces, molded features, retractable features, and such like may all be employed to provide adequate grip between the load contact portion and a load.

Where the load may be other than a log, it may be appropriate to use some of the possible options rather than others. For instance, the present invention might be used for lifting and trimming structural steel components, in which case toughened synthetic plastic or rubber gripping pads may be more appropriate than teeth. Similarly, in different embodiments of the present invention, the gripping portion of the load contact portion may be constructed of different types of material. In the logging industry metal features able to grip into a timber, or suitable synthetic materials, might be used however these may not be appropriate for other types of loads.

In addition to the load contact portion being designed to be able to exert a suitable grip on a load, there should also be means for restricting its travel to within the preferred direction. In a preferred embodiment travel in substantially one longitudinal direction is all that is required. It has been previously mentioned that this direction is substantially parallel to the longitudinal axis of a load, which is typically a log in the description and examples being given.

In a preferred embodiment where the load contact portion comprises a plate, guides are provided to restrict movement of the plate in the preferred direction. It should be appreciated various mechanical options exist for allowing movement of the load contact portion relative to the remainder of grapple head assembly. Carriage like assemblies, bearings and wheeled tracks etc, are but some of the possibilities which may be employed in various embodiments.

To effect movement of the load contact portion relative to the remainder of the grapple head assembly, suitable drive means is provided. In a preferred embodiment the drive means comprises a hydraulic cylinder or ram which may be operated by hydraulic fluid, pneumatically, or by other means. One end of the cylinder will ideally be coupled either directly or indirectly to the load contact portion, while the alternate end will preferably be coupled either directly or indirectly to the remainder of the grapple head assembly. The mounting point and capacity of the cylinder should be suitable to allow a considerable force to be exerted so as to allow relative movement between the grapple head assembly and the load.

Alternate drive means may also be used. For instance worm and nuts, and rack and pinions, are all commonly used for transmitting drive from a motor and to effect longitudinal movement of another component. Such arrangements may also be employed in various embodiments of the present invention. These may provide some additional advantage in that finer control over the sliding components can be achievable depending upon the pitch of the screw. However they can also be slower to move a sliding component than a hydraulic ram, and can introduce additional componentry such as a motor, which may be less economical or susceptible to damage than a hydraulic cylinder—apart from cost considerations. However this does not preclude their use which may be preferred in certain applications. Other types of drive means may also be employed in the various embodiments of the present invention.

In practice, the grapple head assembly can be used to lift and transport a load, such as a log, to a suitable resting point. Ideally the log will be supported such that the portion where a cut is to be made, is free of ground. It may be sufficient for the load/log to remain cradled within the gripping arms of the grapple assembly so as to achieve the desired ground clearance (and thus avoid contact between the saw and the ground). Hence the gripping arms should ideally be relaxed but sufficient downward pressure provided (typically by the weight of the grapple head assembly) so that the load contact portion, or at least the gripping portion thereof, can contact the top of the load/log. Ideally at this stage the grapple mounted trim saw is positioned approximately in the position of the desired position of cutting. The operator, by use of a different control mechanism, can then operate the drive means so that the load contacting portion moves relative to the grapple head assembly. By such movement the grapple head assembly, and the thus the head mounted trimming saw, can be precisely maneuvered so that as it is able to perform a cut at the desired position. Once suitably maneuvered the trim saw is operated to effect the cut.

It should be also appreciated that modifications and additions exist. For instance the sliding plate could be substituted by driven rollers, preferably with a gripping outer face. A pivoting link arrangement could be used to effect movement of the plate in other embodiments. A variety of modifications and equivalents exist which may be employed in different embodiments of the invention.

As should be appreciated, the present invention described herein allows for the type of precise and controlled movement desirable for accurate alignment of a component, such as a trimming saw, with a specific point on a length of a log. This is much more accurate, and potentially quicker, than for even a skilled operator attempting to move the whole grapple head assembly relative to the log.

While the trim saw assembly can be mounted on a sliding assembly to allow its position relative to the grapple head assembly (and hence log) to be changed, this is not always a satisfactory solution. Such modifications make the fragile trim saw assembly even more vulnerable to damage. Even a mild knock against an object can misalign components so that the trimming saw assembly is no longer able to produce a perpendicular cut through the log, which may then result in jamming or inefficient cutting technique. The problems of the side mounted trimming saws used in the industry are well known to operators, though some aspects have also been addressed by the current inventor in a co-pending application directed to saw motor damage. Accordingly, the shifting arrangement proposed in the present invention provides, it is considered, a more useful and useable solution for load cutting operations, particularly in logging and forestry applications.

### DESCRIPTION OF DRAWINGS

FIG. 1 is a front diagrammatic view of a modified grapple head assembly according to a preferred embodiment of the present invention,

FIG. 2 is a side cross sectional diagrammatic view of the embodiment of FIG. 1, with the controlling ram closed FIG. 3 is a further front diagrammatic view of the embodiment of FIG. 1,

FIG. 4 is a further view of FIG. 3 with the controlling ram open,

FIG. 5 is a perspective diagrammatic view of the load contacting portion according to the embodiment of FIG. 1, and

FIG. 6 is a perspective diagrammatic view of part of a grapple and cut-off saw arrangement, in a preferred embodiment.

### DESCRIPTION OF PREFERRED EMBODIMENT

With reference to the drawings and by way of example only is provided a grapple head assembly (generally indicated by arrow 1) having jaws (2, 3) and head portion (4). The grapple head assembly also includes load position adjustment means (5) which in turn includes a load contact portion (generally indicated by arrow 6). There is also an associated drive means (7) in the form of a hydraulic cylinder for effecting relative longitudinal movement of the load contact portion (6).

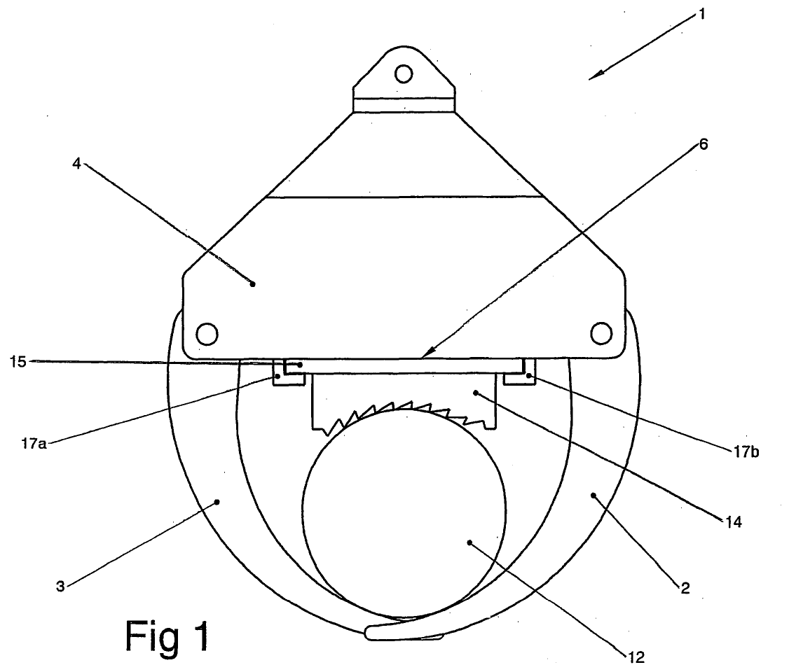

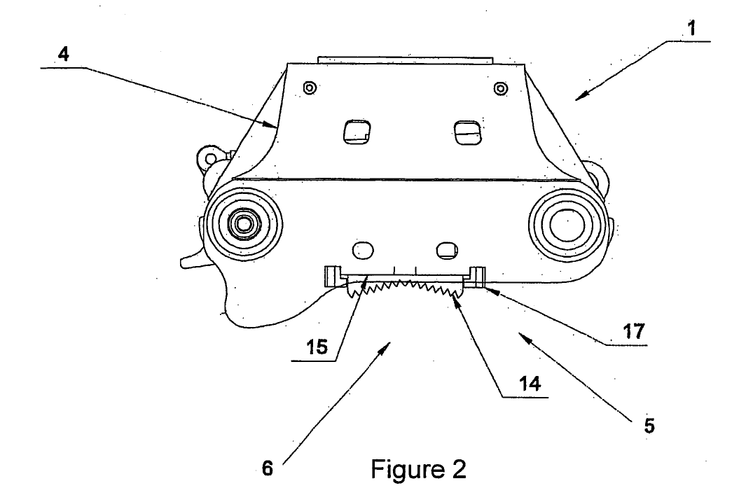

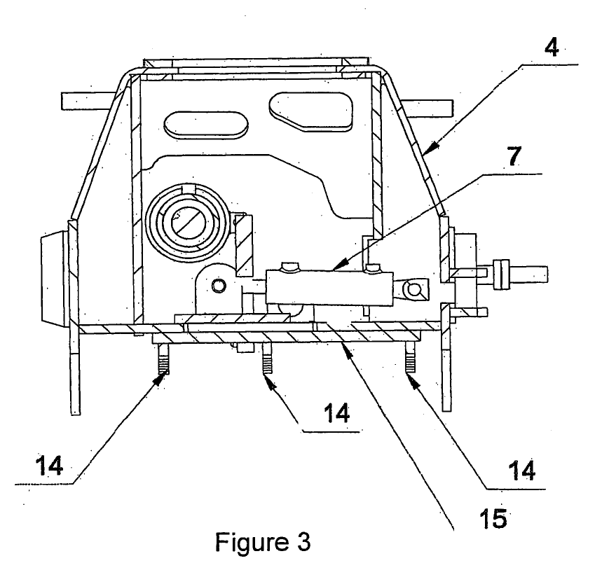

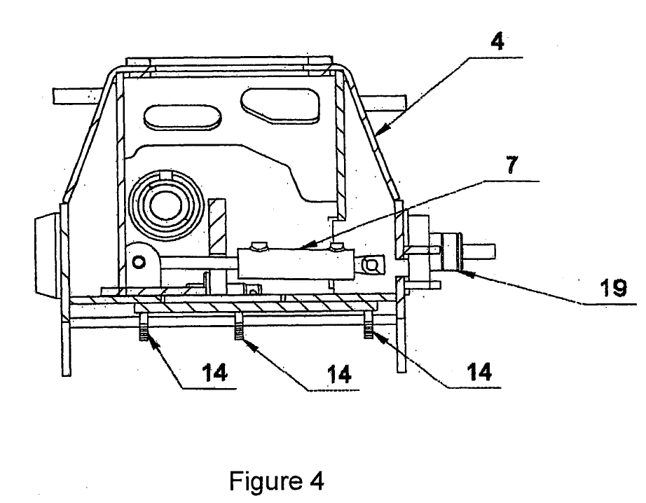

Referring to FIG. 1 the typical load, a log, is indicated as (12). Being held by jaw arms (2 and 3) it can be seen that contact is made by gripping portion (14) of the load contact portion (6). Gripping portion (14a-c) comprises a series of plates welded to a supporting base plate (15), such that their (14a-c) planes are substantially perpendicular to the plane of the supporting base plate (15).

The lower edge of each gripping plate (14) is serrated and follows a curved portion substantially commensurate to the largest diameter log able to be encompassed by arms (2, 3). When a smaller log (12) such as illustrated in FIG. 1, is gripped the contact between log (12) and gripping plate (14) is substantially near the middle of the latter. By relaxing the arms (2, 3), and also allowing at least part of the weight of the grapple head (4) to rest on log (12), reasonable contact can be made between the gripping plates (14 and 12) to the extent that movement of the grapple head (4) relative to the log (12) may be made in a direction substantially parallel to the longitudinal axis of log (12).

The load contacting portion, and more specifically the base plate (15), is supported by a pair of guides (17a, b) which also allow for sliding movement in the permitted longitudinal (relative to the log) direction. Teflon liners or bearings may be used within the guide (17a, b) to facilitate sliding movements of the base plate (16).

To effect movement the hydraulic cylinder (7) is coupled to a suitable mounting point (18) attached to base plate (15). The alternate end of cylinder (7) is attached to a suitable mounting point (19) on the grapple head (4). By contracting or extending the hydraulic cylinder, movement of the base plate (15) and attached components can be effected. Providing that the log is not tightly held within the jaws (2, 3) or some other means is not preventing relative movement of the grapple head assembly (1) and log (12), the effect of operating cylinder (7) is typically to move the grapple head portion (4) relative to the log (12). In this manner the operator can accurately align the trimming saw (20) with respect to the length of log (12) so that a cut may be made at the desired point along the length of the log (12).

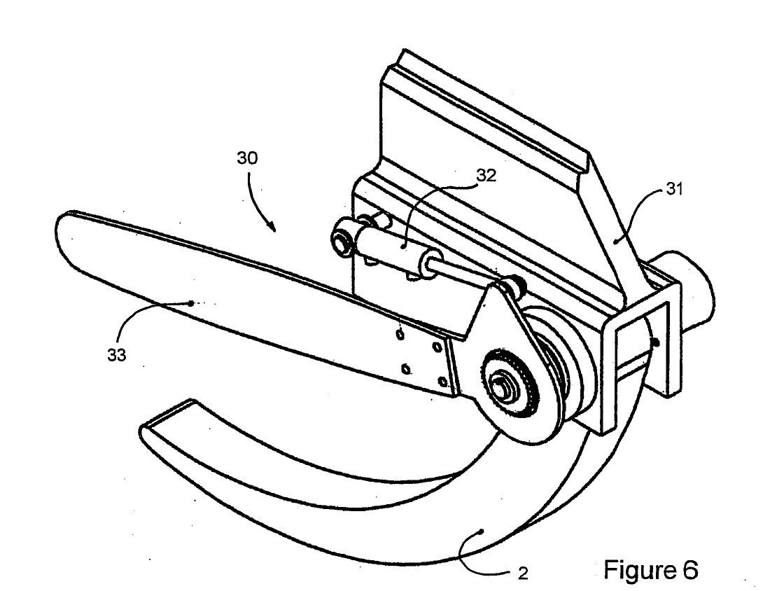

FIG. 6 focuses on a cut-off saw (30), which is generally pivotally mounted to one of the plates (31) of the head portion (4). A cylinder (32) controls whether the pivotally mounted chainsaw can pivot its bar (33) and chain (not shown for clarity) downwardly to perform a trimming operation. As can be seen, the only permitted movement of the bar (33) and chain is a downward pivoting—i.e. it cannot alter its position relative to the length of a log (12) unless the whole grapple is moved relative to the log.

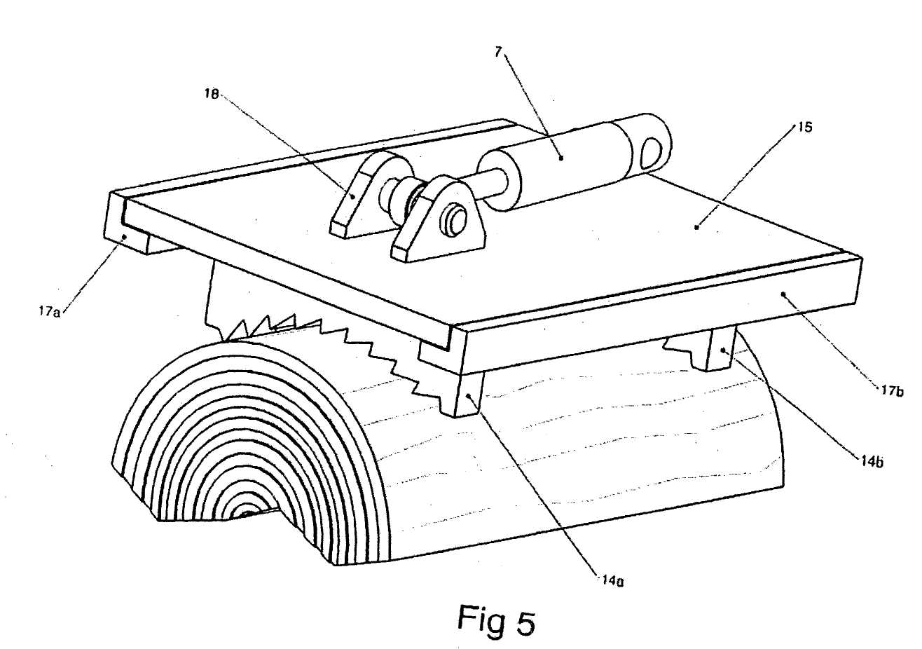

FIG. 5 more clearly shows various components including the base plate (15) which supports gripping plates (14a, b). The guides (17a, b) are also visible which guide and restrict movement of the base plate (15) to substantially a direction parallel to the longitudinal axis of the log. A hydraulic cylinder (7) attached at one end to a mounting point (18) on the base plate (15) is also attached at its distal end to the head portion (not visible in FIG. 5) of the grapple. Extension and contraction of this cylinder (7) results in movement of the base plate (15), along with the gripping plates (14a, b) and log (providing sufficient purchase is achieved through operator control), relative to the remainder of the head portion of the grapple.

A kitset for use with the present invention may comprise the load contacting portion/assembly (6), including a guide assembly (17), and a cylinder (7). Accordingly, existing grapple head assemblies may be modified to employ the present invention, though it is envisaged that it may be more cost effective to implement the present invention on new grapple head assemblies of specific design.

It is also envisaged that grapple head assemblies which incorporate the load shifting arrangement and which also fall within the scope of the present invention, may not necessarily include the trimming saw, but allow this to be added as an after market extra according to user choice or preference.

Aspects of the present invention have been described by way of example only and it should be appreciated that modifications and additions may be made thereto without departing from the spirit or scope of the present invention as described herein.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being authoritative disclosure on the true state of the prior art but rather as referencing considerations brought to the mind and attention of the inventor when developing this invention.

1. A disc section for use in a disc assembly, said disc section either or both bearing grinding teeth, or allowing for the attachment of same;
there being provided a first face for bearing against a supporting hub;
there being second and third faces extending from the first face, to a fourth outer face;
there being positioned at the intersection of either or both the second with fourth, or
third with fourth faces, a tapered removed portion accommodating part of a retaining segment connectable to said hub.

2. A disc section as claimed in claim 1 in which the exposed face of the tapered removed portion is substantially planar.

3. A disc section as claimed in claim 1 in which a second or third face associated with a tapered removed portion includes additional removed portions to accommodate connection means for said retaining segment to the hub.

4. A disc section as claimed in claim 1 which includes a grinding tooth wherein said grinding tooth includes a tip comprising materials selected from the group: toughened steel, tungsten carbide, diamond, boron nitride, and ceramic materials.

5. A disc section as claimed in claim 1 which includes an aperture for accommodating the body of a grinding tooth in turn comprising a tooth assembly comprising a tooth portion and a body.

6. A disc section as claimed in claim 5 in which an aperture is positioned to support a grinding tooth to extend from the fourth said face of the disc section.

7. A disc section as claimed in claim 5 in which an aperture is positioned to support a grinding tooth to extend from either or both a fifth or sixth, front and rear, face of the disc section.

8. A disc section as claimed in claim 1 in which the bottom first face of the disc section is slotted to accommodate a circumferential flange of the hub.

9. A disc section as claimed in claim 1 such that the tapered removed portion of said disc section, in combination with the tapered removed portion in a side by side adjacent second disc section, the combined shape and volume defined by the tapered removed portions approximate and accommodate a said retaining segment

10. A disc section as claimed in claim 1 in which there is a tapered removed portion at both the intersection of the second with fourth, and third with fourth, faces, and in which when two identical discs placed side by side adjacently such that the second face of one is face to face adjacent with the third face of the other, the shape and volume defined by the tapered removed portions associated with those faces approximate and accommodate a said retaining segment.

11. A disc section as claimed in claim 1 in which the tapered removed sections do not extend fully to the fifth and sixth, front and rear, faces of the disc section.

12. A disc section as claimed in claim 1 in which the interaction between a retaining segment and the tapered removed portion of a disc section is such that moving the retaining segment in a radial direction closer to the hub exerts a force with a perpendicular (relative to a radial line from the hub) component against said disc section when its first face bears against said hub.

13. A retaining segment for use with a disc section as claimed in claim 1, said retaining segment being either or both substantially tapered trapezoidal, or triangular, when viewed from its front;
said segment including provision for a connection element passing from said segment to the hub.

14. A retaining segment as claimed in claim 13 in which the connection element comprises a bolt which passes through the retaining segment, and extends and connects to a removable insert positionable in the hub; the head of said bolt being exposed in relation to the retaining segment to allow its adjustment, and wherein the adjustment is such as to release or draw the retaining segment towards the hub.

15. A retaining segment as claimed in claim 14 in which the removable insert is configured such that it may only be inserted into the hub in the correct orientation.

16. A disc assembly comprising a hub, and a plurality of disc sections as claimed in claim 1, positioned side by side adjacently thereabout;
the disc sections being maintained in position by retaining segments acting on adjacent disc sections, and which retaining segments are connected to the hub or a component associated with the hub;
a said retaining segment being substantially tapered trapezoidal in appearance and bearing against tapered removed portions associated with the disc sections, the relationship being further characterised in that tightening the connection between a retaining segment and the hub, or a component associated therewith, exerts a force on the associated disc sections having both radially directed and perpendicular, relative to the radial, components.

17. A disc assembly comprising a hub bearing a circumferential flange;
there being located about the hub and located over the flange a plurality of adjacent disc sections, each being substantially segment shaped in front elevation but with a removed bottom portion corresponding to the position occupied by the hub;
each disc section possessing at the intersection of its outermost face and faces contacting adjacent disc sections, a tapered removed portion which, collectively between two adjacent disc sections, defines substantially a wedge shape;
there being provided retaining segments insertable into the wedge shape defined by adjacent tapered removed portions, and which retaining segments are connected by connection elements to the hub or a part associated therewith;
said connection elements forming an adjustable connection which allows the retaining segments to be drawn towards the hub, the resulting interaction on their associated disc sections being to help secure the disc sections to the hub,
the connection elements also providing for removal of the retaining segments, and consequentially disc sections, for replacement.

18. A method of retaining disc sections in a rotatable disc assembly such that the resulting energy from local resistance to rotation applied to a single disc section is absorbed at least partially by a retaining segment and/or its associated fastening connection.

19. A method as claimed in claim 18 wherein the energy from local resistance to rotation applied to a single disc section is also transmitted at least partially at least an adjacent disc, and its associated retaining segments.

20. A method of retaining disc sections in a rotatable disc assembly such that the resulting energy from local resistance to rotation applied to a single disc section is absorbed at least partially by a retaining segment and/or its associated fastening connection, wherein the disc section is a disc section as claimed in claim 1, and is retained by a said retaining segment connected to the hub.
